(19) United States
(12) Patent Application Publication
(10) Pub. No.: US 2018/0037086 A1
(43) Pub. Date: Feb. 8, 2018

(54) VEHICLE APPARATUS

(71) Applicant: Robert Bosch GmbH, Stuttgart (DE)

(72) Inventors: Dana Nicgorski, Salem, MA (US); Karsten Mischker, Leonberg (DE); Oliver Tschismar, Metzingen (DE); Thomas Helming, Baden-Baden (DE); Thomas Holzer, Karlsbad (DE)

(21) Appl. No.: 15/245,770

(22) Filed: Aug. 24, 2016

(30) Foreign Application Priority Data
Aug. 8, 2016 (DE) 10 2016 214 623.8

(51) Int. Cl. B60H 1/00; B60H 1/32; B60H 1/22

(52) U.S. Cl. CPC B60H 1/00885; B60H 1/00278; B60H 1/2215; B60H 1/323; B60H 2001/00307; B60H 2001/00928; B60H 2001/00957

(57) ABSTRACT

A vehicle apparatus (10a; 10b; 10c) having at least one thermal management unit (12a; 12b; 12c) which has at least one first throughflow region (14a; 14b; 14c) and at least one second throughflow region (16a; 16b; 16c), which are connectable in accordance with demand in each case to a first heat circuit (18a) and/or to a second heat circuit (20a), and has a heat-exchange unit (22a; 22b; 22c) which, in at least one operating state, exchanges heat in accordance with demand between the first throughflow region (14a; 14b; 14c) and the second throughflow region (16a; 16b; 16c).

### BACKGROUND OF THE INVENTION

A vehicle apparatus having at least one thermal management unit which has at least one first throughflow region and at least one second throughflow region which are connectable in accordance with demand in each case to a first heat circuit and/or to a second heat circuit, and has a heat-exchange unit which, in at least one operating state, exchanges heat in accordance with demand between the first throughflow region and the second throughflow region, has already been proposed. Such vehicle apparatuses, which are used for the thermal management in vehicles, are based on the use of air and/or refrigerants of air-conditioning installations.

### SUMMARY OF THE INVENTION

The invention is based on a vehicle apparatus having at least one thermal management unit which has at least one first throughflow region and at least one second throughflow region, which are connectable in accordance with demand in each case to a first heat circuit and/or to a second heat circuit, and has a heat-exchange unit which, in at least one operating state, exchanges heat in accordance with demand between the first throughflow region and the second throughflow region.

It is proposed that the first throughflow region and the second throughflow region are provided for being flowed through in each case by a heat-transporting liquid which differs from a refrigerant.

A “vehicle apparatus” is to be understood in particular to mean an in particular functional component, in particular a structural and/or functional component, of a vehicle, in particular of an electric vehicle, of a vehicle with an internal combustion engine or of a vehicle with hybrid drive, advantageously of the thermal management topology thereof. In particular, the vehicle apparatus comprises the entire thermal management topology. The vehicle apparatus is advantageously a central module of a thermal management topology of a vehicle, in particular of an electric vehicle. The first throughflow region and/or the second throughflow region advantageously comprises at least one line for a liquid.

The heat-exchange unit preferably comprises at least one first heat exchanger with a first side which is in thermal contact with the first throughflow region. The heat-exchange unit particularly preferably comprises at least one second heat exchanger with a first side which is in thermal contact with the second throughflow region. The heat-exchange unit advantageously comprises at least one inner heat circuit which connects a second side of the first heat exchanger to a second side of the second heat exchanger. The heat circuit of the heat-exchange unit is particularly advantageously in the form of a refrigerant circuit. It is preferably the case that, in the operating state, the first side of the first heat exchanger is in thermal contact with the second side of the first heat exchanger. It is furthermore the case, preferably in the operating state, that the first side of the second heat exchanger is in thermal contact with the second side of the second heat exchanger.

In particular, the heat-transporting liquid is liquid above a temperature of at least −50° C., advantageously of at least −20° C. and particularly advantageously of at least −10° C. and/or below a temperature of at most 200° C., advantageously of at most 150° C. and particularly advantageously of at most 110° C. The heat-transporting liquid is advantageously a coolant, in particular cooling water. In this context, “cooling water” is to be understood in particular to mean a water-based heat-transporting liquid, in particular a water-antifreeze mixture, for example a water-glycol mixture. It is also conceivable for the coolant to have oil and/or other suitable liquids. It is preferably the case that, in the operating state, the first throughflow region and/or the second throughflow region are in particular completely filled with the heat-transporting liquid. In particular, in the operating state, the heat-transporting liquid in the first throughflow region and/or the heat-transporting liquid in the second throughflow region is free from gas bubbles.

It is preferably the case that the first throughflow region and the second throughflow region are connectable to further heat circuits. In particular, the further heat circuits may be partial circuits of the first heat circuit and/or of the second heat circuit. It is conceivable for the first heat circuit and/or the second heat circuit to be configured differently in a manner dependent on an operating mode and/or on an operating state and in particular in accordance with the operating mode and/or operating state. In particular, the first heat circuit and/or the second heat circuit is, in accordance with the operating state, a particular part, in particular a particular sub-circuit, of a thermal management topology, in particular of the vehicle apparatus. It is likewise conceivable for the first heat circuit and/or the second heat circuit to be at least substantially unchanged in different operating modes, and to merely be connected alternatively to the first throughflow region and/or to the second throughflow region in accordance with the operating mode.

By way of the configuration of the vehicle apparatus according to the invention, it is possible to realize advantageous characteristics with regard to a high level of variability and/or a high level of efficiency. It is advantageously possible for a required amount of refrigerant to be reduced. Furthermore, it is advantageously possible to provide a vehicle apparatus which can be used in a versatile manner and in particular in different cooling topologies. Furthermore, it is possible to realize a high level of efficiency with regard to residual heat utilization. Furthermore, it is advantageously possible for different components of a vehicle, in particular of an electric vehicle, to be cooled or heated in a reliable and/or efficient manner in accordance with demand. Furthermore, it is possible to realize a high level of flexibility with regard to different operating modes for targeted pre-heating and/or heating and/or pre-cooling and/or cooling of particular components of a vehicle. Furthermore, a generation of noise can advantageously be reduced. In particular for quiet electric vehicles, it is possible for background noises, which are perceived as disturbing, to be reduced. It is advantageously also possible to permit a spontaneous response in the case of heating in accordance with demand. Furthermore, a compact construction can be made possible.

Furthermore, the invention is based on a vehicle apparatus having at least one thermal management unit which has at least one first throughflow region and at least one second throughflow region, which are connectable in accordance with demand in each case to a first heat circuit and/or to a second heat circuit, and has a heat-exchange unit which, in at least one operating state, exchanges heat in accordance with demand between the first throughflow region and the second throughflow region.

It is proposed that the thermal management unit has at least one auxiliary heater which, in the operating state, generates heat in accordance with demand for the first throughflow region and/or for the second throughflow region.

The auxiliary heater advantageously comprises at least one electric heating element. In particular, the auxiliary heater is provided for supplying heat in accordance with demand to the heat-transporting liquid in the first throughflow region and/or to the heat-transporting liquid in the second throughflow region. The auxiliary heater is preferably assigned either to the first throughflow region or to the second throughflow region. It is also conceivable for the first throughflow region and the second throughflow region to be assigned in each case one auxiliary heater. It is advantageously the case that at least one part of the auxiliary heater, which part is in particular flowed around by the heat-transporting liquid in the operating state, is arranged in the first throughflow region and/or in the second throughflow region.

In this way, it is possible to realize advantageous characteristics with regard to a spontaneous response behavior. In particular, it is possible for heat to be generated in accordance with demand more quickly than with a heat pump. Furthermore, it is advantageously possible for an efficiency, for example of a heat pump, in particular in the presence of low temperatures, for example below −7° C., to be increased. Furthermore, a compact construction can be made possible. Furthermore, in this way, it is possible for vehicle windows to be de-iced advantageously quickly.

In an advantageous refinement of the invention, it is proposed that the auxiliary heater comprises at least one heating element, in particular a PTC heating element, in particular the electric heating element, which has at least one material with a positive temperature coefficient. Here, the abbreviation “PTC” stands for “positive temperature coefficient”. The PTC material is preferably a ceramic or a plastic. The heating element is particularly preferably electrically operable. It is advantageously the case that, above a particular temperature of the material of the heating element, the electrical resistance thereof increases to such an extent that burning-through of the material of the heating element can be prevented. In particular, the heating element is in the form of a self-regulating heating element. In this way, it is advantageously possible for fast heating to be made possible. Furthermore, in this way, overheating can be prevented in an effective manner.

Furthermore, the invention is based on a vehicle apparatus having at least one thermal management unit which has at least one first throughflow region and at least one second throughflow region, which are connectable in accordance with demand in each case to a first heat circuit and/or to a second heat circuit, and has a heat-exchange unit which, in at least one operating state, exchanges heat in accordance with demand between the first throughflow region and the second throughflow region.

It is proposed that the heat-exchange unit comprises at least one electrochemical compressor. In particular, the electrochemical compressor is provided for compressing a refrigerant of the heat-exchange unit. The electrochemical compressor advantageously has at least one membrane for the transport of ions. In particular, the membrane is an electrolyte membrane, preferably a polymer electrolyte membrane. The electrochemical compressor particularly advantageously has at least one anode and at least one cathode for the generation of an electrical field for ion transport through the membrane. It is preferably the case that anions and cations are transported through the membrane and are particularly preferably correspondingly oxidized and/or reduced after the transport. It is advantageously the case that molecules and/or atoms of the refrigerant of the heat-exchange unit are ionized before the transport. In particular, the electrochemical compressor is provided for generating a pressure of at least 1 bar, advantageously of at least 5 bar, particularly advantageously of at least 10 bar, preferably of at least 100 bar and particularly preferably of at least 500 bar, wherein even higher pressures are also conceivable. In this way, it is advantageously possible for a generation of noise to be reduced. Furthermore, in this way, it is advantageously possible to realize a long service life.

In a preferred refinement of the invention, it is proposed that the heat-exchange unit comprises at least one heat pump for the heat exchange. In particular, the heat pump, in the operating state, exchanges heat between the first throughflow region and the second throughflow region. The heat pump is advantageously provided for exchanging heat between the second side of the first heat exchanger and the second side of the second heat exchanger. It is particularly advantageously the case that the heat pump, in the operating state, pumps heat from the colder of the two throughflow regions to the warmer of the two throughflow regions. In particular, the heat pump has at least one compressor, in particular the electrochemical compressor. In this way, it is advantageously possible to realize a high level of flexibility with regard to thermal management. Furthermore, it is advantageously possible for heat to be exchanged in an efficient manner between different heat circuits of a coolant topology.

In an advantageous refinement of the invention, it is proposed that the thermal management unit has a pump unit which comprises at least one pump which, in the operating state, generates a flow in the first throughflow region and/or in the second throughflow region. The thermal management unit advantageously comprises multiple pumps which are assigned to in each case one heat circuit and/or to in each case one sub-circuit and/or to in each case one of the throughflow regions. The pump is particularly advantageously designed such that it can be actuated in a manner dependent on an operating mode of the vehicle apparatus and/or of the thermal management apparatus. The pump preferably generates a different flow in the first heat circuit and/or in the second heat circuit and/or in the first throughflow region and/or in the second throughflow region in accordance with the operating mode. The pump is preferably designed to be electrically actuable. In this way, it is advantageously possible to permit usage in different thermal management topologies. Furthermore, it is possible in this way to realize simple and/or flexible and/or convenient programmability.

In a particularly advantageous refinement of the invention, it is proposed that the thermal management unit has a switching unit which comprises at least one valve by means of which a connection state of the first heat circuit and of the second heat circuit to the heat-exchange unit, in particular to the first throughflow region and/or to the second throughflow regions, can be adapted in accordance with demand. The switching unit preferably comprises a multiplicity of valves. It is particularly preferably the case that an operating state of the thermal management unit is defined, and/or can be defined, by way of a position of the valve or of the valves, in particular in combination with an operating state of the pump unit. In this way, it is advantageously possible to realize different operating modes in an easily retrievable manner.

The thermal management unit advantageously has at least one control unit which is provided for actuating the pump unit and/or the switching unit, in particular in a manner dependent on a selectable and/or selected operating mode. The control unit preferably has at least one interface which permits a transmission of external control signals, for example of a central control unit of a vehicle, to the control unit. The control unit is particularly preferably provided for processing external control signals and/or actuating the pump unit and/or the switching unit in a manner dependent on external control signals.

In a further refinement of the invention, it is proposed that the valve is a multi-way valve and/or a proportional valve. In particular, the switching unit has multiple valves, of which at least some or all are in the form of multi-way valves and/or proportional valves. The switching unit is preferably provided for actuating the proportional valve differently in a manner dependent on operating mode, in order to adjust or regulate a flow through the proportional valve to a setpoint value. In this way, it is advantageously possible to realize a high level of flexibility with regard to control of coolant flows.

It is also proposed that the thermal management unit is in the form of a separate structural unit. In particular, the thermal management apparatus is in the form of a thermal management module. The thermal management system advantageously has ports for the first heat circuit and for the second heat circuit. In accordance with the operating mode of the thermal management unit, in particular in accordance with the valve position and/or operating mode of the pump unit, the ports can be connected to the first heat circuit and/or to the second heat circuit. The ports are preferably in the form of ports for coolant lines. The ports are particularly preferably in the form of plug-type connections, which permit installation in particular without the use of tools. In this way, it is advantageously possible for easy and/or fast installation into an existing thermal management topology, or into a thermal management topology to be constructed, to be made possible. Furthermore, versatile usability can be realized in this way.

In a preferred refinement of the invention, it is proposed that the thermal management unit has a housing unit which houses at least the heat-exchange unit. The housing unit preferably houses all of the components of the thermal management unit, in particular also the switching unit and the pump unit. The housing unit particularly preferably has the port. In this way, it is advantageously possible for a modular construction of a thermal management topology to be made possible. Furthermore, in this way, it is possible to provide a central module, which can be used in a variable manner, for thermal management topologies, in particular of vehicles or electric vehicles.

In a particularly preferred refinement of the invention, it is proposed that the housing unit has the ports for the first heat circuit and for the second heat circuit. In this way, it is advantageously possible to realize easy assemblability.

It is also proposed that the vehicle apparatus has the first heat circuit and the second heat circuit which, in the operating state, are flowed through by a coolant, in particular by the heat-transporting liquid. In this way, an advantageous coordination of different components can be made possible.

Advantageous characteristics with regard to a high level of variability and/or flexible usability, in particular in different vehicle types and/or different thermal management topologies, can be achieved with a thermal management system for a vehicle apparatus according to the invention and in particular with a thermal management unit according to the invention.

Advantageous characteristics with regard to a high level of efficiency and/or a high level of comfort, in particular owing to a low level of noise generation, can be achieved with a vehicle having a vehicle apparatus according to the invention.

Here, the vehicle apparatus according to the invention is not intended to be restricted to the usage and embodiment described above. In particular, the vehicle apparatus according to the invention may, in order realize a functionality described herein, have a number of individual elements, components and units which differs from a number stated herein. Furthermore, in the case of the value ranges specified in this disclosure, values lying within the stated limits are also intended to be disclosed and usable as desired.

### BRIEF DESCRIPTION OF THE DRAWINGS

Further advantages will emerge from the following description of the drawing. The drawing illustrates three exemplary embodiments of the invention. The drawing, the description and the claims contain numerous features in combination. A person skilled in the art will expediently also consider the features individually and combine them to form further meaningful combinations.

In the drawings, lines or line branches are, in part, denoted by different symbols for the sake of clarity. Said symbols are intended to represent possibly occurring different temperatures or temperature ranges of corresponding heat-transporting liquids, but are not to be understood as being restrictive. In particular, occurring temperatures in some or all of the lines may also exhibit a different distribution to that illustrated. In particular, a temperature may also vary along a line, even though the line is denoted by the same symbol throughout. The symbols are therefore to be understood exclusively as schematic aids for better understanding. For better understanding of the exemplary embodiments, the meaning of the symbols may be interpreted as follows: circle—hot, triangle—very warm, hexagon—warm, rhombus—cool, square—cold.

In the drawings:

FIG. 1 is a schematic illustration of a vehicle apparatus having a thermal management unit in a first operating state,

FIG. 2 shows a heat-exchange unit in the thermal management unit in a schematic illustration,

FIG. 3 shows a first heat exchanger of the heat-exchange unit having an auxiliary heater in a schematic plan view,

FIG. 4 shows an alternative heat exchanger having an auxiliary heater in a schematic plan view,

FIG. 5 shows the alternative heat exchanger in a schematic side view,

FIG. 6 shows the first heat exchanger of the heat-exchange unit in a schematic sectional illustration,

FIG. 7 is a schematic illustration of the vehicle apparatus in a second operating state,

FIG. 8 is a schematic illustration of the vehicle apparatus in a third operating state,

FIG. 9 is a schematic illustration of the vehicle apparatus in a fourth operating state,

FIG. 10 is a schematic illustration of the vehicle apparatus in a fifth operating state,

FIG. 11 is a schematic illustration of the vehicle apparatus in a sixth operating state,

FIG. 12 is a schematic illustration of the vehicle apparatus in a seventh operating state,

FIG. 13 shows the thermal management unit of the vehicle apparatus in a schematic illustration,

FIG. 14 is a schematic illustration of a second vehicle apparatus having a thermal management unit, and

FIG. 15 is a schematic illustration of a third vehicle apparatus.

### DETAILED DESCRIPTION

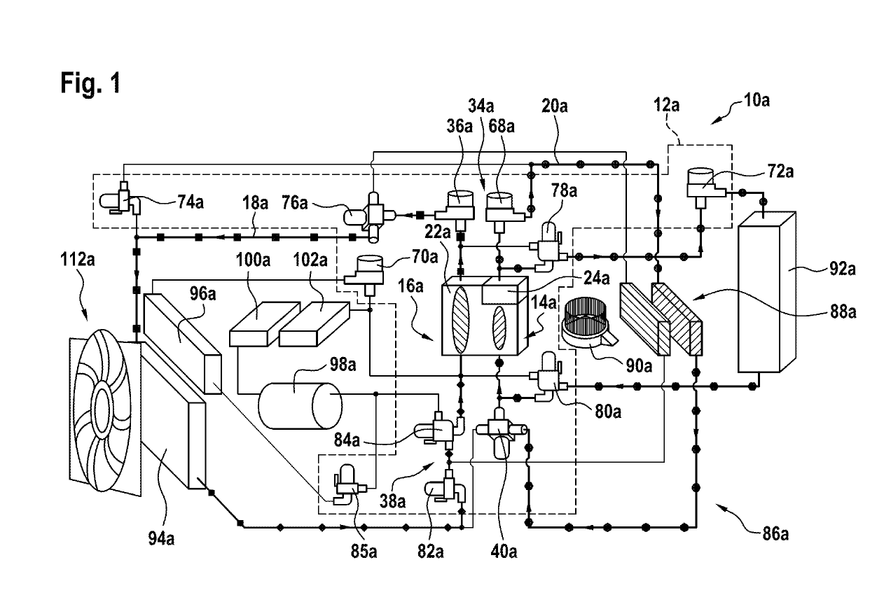

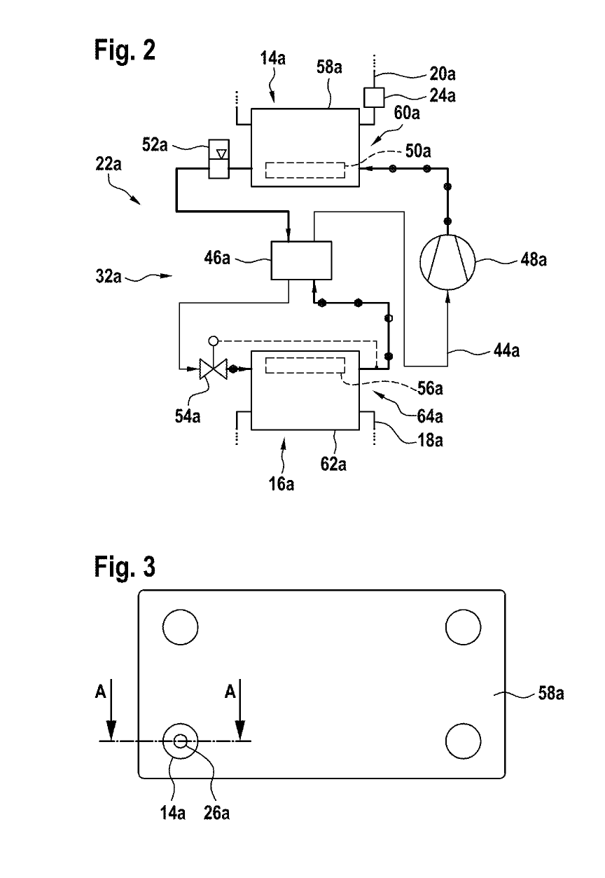

FIG. 1 is a schematic illustration of a vehicle apparatus 10a having a thermal management unit 12a in a first operating state. The thermal management unit 12a has a first throughflow region 14a and a second throughflow region 16a which are connectable in accordance with demand in each case to a first heat circuit 18a and/or to a second heat circuit 20a. The thermal management unit 12a has a heat-exchange unit 22a which is illustrated schematically in FIG. 2. The heat-exchange unit 22a, in the first operating state, exchanges heat between the first throughflow region 14a and the second throughflow region 16a. The first throughflow region 14a and the second throughflow region 16a are provided for being flowed through in each case by a heat-transporting liquid which differs from a refrigerant. In the present case, the throughflow regions 14a, 16a are in the form of coolant line sections.

The heat-exchange unit 22a has a heat pump 32a for the heat exchange. The heat pump 32a comprises an internal heat circuit 44a with an internal heat exchanger 46a, by way of which an efficiency of the heat pump 32a can be increased. The internal heat circuit 44a is a refrigerant circuit. The heat pump 32a furthermore comprises at least one compressor 48a, at least one condenser 50a, at least one accumulator 52a, at least one expansion valve 54a, for example a thermostatic expansion valve and/or an electric expansion valve, and at least one evaporator 56a.

The heat-exchange unit 22a has a first heat exchanger 58a. The first heat exchanger 58a is assigned to a hot side 60a of the heat pump 32a. The first throughflow region 14a lies within the first heat exchanger 58a. The first throughflow region 14a is in thermal contact with the hot side 60a of the heat pump 32a. Furthermore, the heat-exchange unit 22a has a second heat exchanger 62a. The second heat exchanger 62a is assigned to a cold side 64a of the heat pump 32a. The second throughflow region 16a lies within the second heat exchanger 62a. The second throughflow region 16a is in thermal contact with the cold side 64a of the heat pump 32.

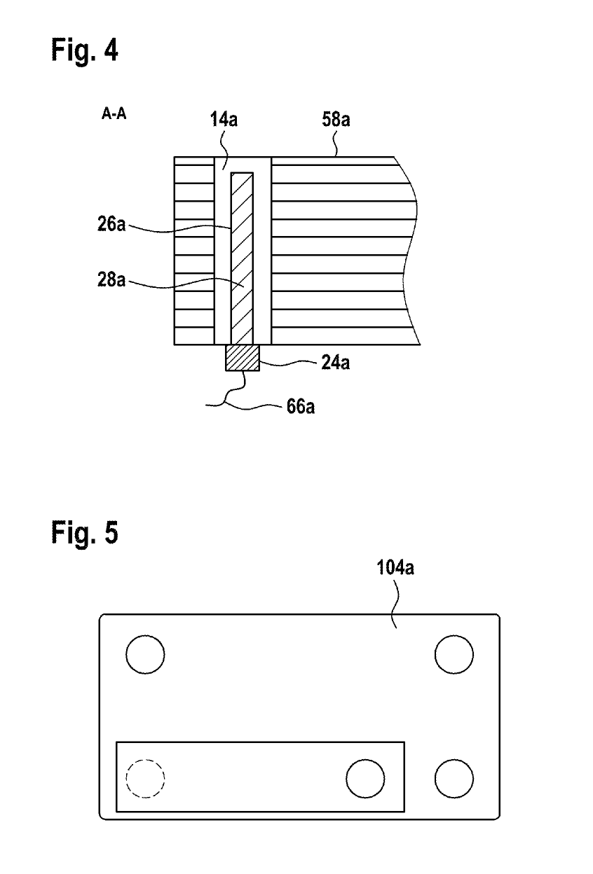

The first heat exchanger 58a is illustrated schematically in FIGS. 3 and 4. FIG. 3 shows the first heat exchanger 58a in a schematic plan view. FIG. 4 shows the first heat exchanger 58a in a schematic sectional illustration along the section plane A-A in FIG. 3.

The thermal management unit 22a has an auxiliary heater 24a which, in the first operating state, generates heat in accordance with demand for the second throughflow region 16a. The auxiliary heater 24a is arranged in the second throughflow region 16a. The auxiliary heater 24a is arranged within the first heat exchanger 58a. It is alternatively or additionally conceivable for an auxiliary heater to be arranged in the first throughflow region 14a. The auxiliary heater 24a comprises a heating element 26a which has at least one material 28a with a positive temperature coefficient. In the present case, the heating element 26a is in the form of an electric PTC heating element. The heating element 26a has an electrical terminal 66a. In the first operating state, heating element 26a is flowed around by the heat-transporting liquid in the second heat circuit 20a. The auxiliary heater 24a can be activated in accordance with demand if it is sought to quickly increase a temperature in the second throughflow region 16a, for example upon starting of the thermal management unit 22a and/or in the presence of low ambient temperatures.

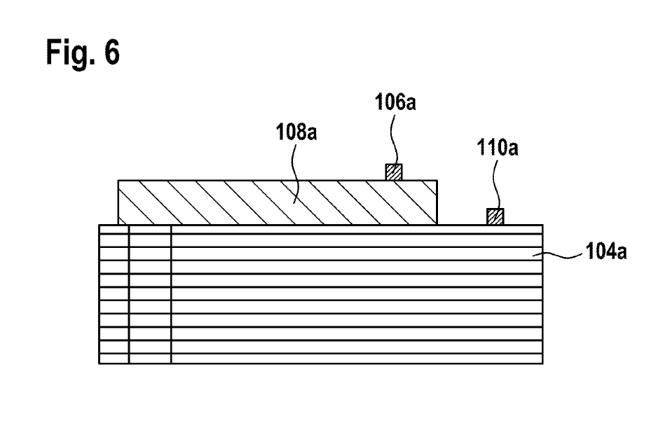

FIGS. 5 and 6 are schematic illustrations of an alternative heat exchanger 104a which can be used for example instead of the heat exchanger 58a. The alternative heat exchanger 104 has a port 106a which is connectable to a coolant line. The port 106a is connected to an auxiliary heater 108a which, during operation, is flowed through by coolant. The auxiliary heater 108a is arranged on a top side of the alternative heat exchanger 104a. In the present case, the auxiliary heater 108a is in the form of an auxiliary heating module which can be mounted on a conventional heat exchanger. In particular, in this way, a conventional heat exchanger can be equipped with an auxiliary heater without further adaptations being required. Furthermore, the alternative heat exchanger 104a has a further port 110a from which the coolant emerges again during operation. The alternative heat exchanger 104a may comprise a throughflow region which leads from the port 106a to the further port 110a.

As shown in FIG. 1, the thermal management unit 12a has a pump unit 34a which comprises at least one pump 36a, 68a which, in the first operating state, generates a flow in the first throughflow region 14a and/or in the second throughflow region 16a. In the present case, a first pump 36a is assigned to the first throughflow region 14a. Furthermore, in the present case, a second pump 68a is assigned to the second throughflow region 16a. The first pump 36a and the second pump 68a are actuable in accordance with demand in order to generate a flow in the first heat circuit 18a and in the second heat circuit 20a respectively. Analogously, in the present case, the pump unit 34a comprises a third pump 70a and a fourth pump 72a.

Furthermore, the thermal management unit 12a has a switching unit 38a which comprises at least one valve 40a by means of which a connection state of the first heat circuit 18a and of the second heat circuit 20a to the heat-exchange unit 22a can be adapted in accordance with demand. The valve 40a is, in the present case, a multi-way valve, in particular a three-way valve. Furthermore, in the present case, the valve 40a is a proportional valve. The switching unit 38a additionally comprises, in the present case, seven further valves 74a, 76a, 78a, 80a, 82a, 84a, 85a. As presented below, it is possible by way of the switching unit 38a, or by way of the valves 40a, 74a, 76a, 78a, 80a, 82a, 84a, 85a of the switching unit 38a, for a profile of the first heat circuit 18a and of the second heat circuit 20a to be adapted in accordance with the selected operating mode.

In the present case, the vehicle apparatus 10a has the first heat circuit 18a and the second heat circuit 20a which in the first operating state, are each flowed through by a coolant. In the present case, the coolant is a water-glycol mixture. Other suitable coolants are however self-evidently also conceivable.

In the present case, the vehicle apparatus 10a comprises a thermal management topology 86a of an electric vehicle (not shown) which has the vehicle apparatus 10a. The thermal management topology 86a comprises a multiplicity of lines for the heat-transporting liquid, which lines, for the sake of clarity, are not individually denoted by reference designations. The thermal management topology 86a will be described in more detail below.

An outlet of the first throughflow region 14a is connected to a first port of the second pump 68a. A second port of the second pump 68a is connected to an inlet of a hot side of a heat pump 88a which is assigned to an interior compartment ventilation system 90a of a vehicle. An outlet of the hot side of the heat pump 88a is connected to a first port of the valve 40a. A second port of the valve 40a is connected to an inlet of the first throughflow region 14a.

Furthermore, the outlet of the first throughflow region 14a is connected to a first port of a valve 78a. A second port of the valve 78a is connected to an inlet of the fourth pump 72a. An outlet of the fourth pump 72a is connected to an inlet of an energy store 92a. In the present case, the energy store 92 is in the form of a battery of the electric vehicle. An outlet of the energy store 92a is connected to a first port of the valve 80a. A second port of the valve 80a is connected to an inlet of the first throughflow region 14a.

An outlet of the second throughflow region 16a is connected to an inlet of the pump 36a. An outlet of the pump 36a is connected to a first port of the valve 76a. A second port of the valve 76a is connected to a first side 94a of a heat exchanger of a vehicle cooler 112a of the electric vehicle. An outlet of the first side 94 of the heat exchanger of the vehicle cooler 112a is connected to a first port of the valve 82a. A second port of the valve 82a is connected to a first port of the valve 84a. A second port of the valve 84a is connected to an inlet of the second throughflow region 16a.

A third port of the valve 80a is connected to an inlet of the third pump 70a. An outlet of the third pump 70a is connected to an inlet of a second side 96a of the heat exchanger of the vehicle cooler 112a. An outlet of the second side 96a of the heat exchanger of the vehicle cooler 112a is connected to a first port of the valve 85a. A second port of the valve 85a is connected to an inlet of an electric motor 98a of the electric vehicle. An outlet of the electric motor 98a is connected to an inlet of an inverter 100a of the electric vehicle. An outlet of the inverter 100a is connected to an inlet of a charger 102a of the electric vehicle. An outlet of the charger 102a is connected to a third port of the valve 80a. Furthermore, the outlet of the charger 102a is connected to the inlet of the third pump 70a. Furthermore, the inlet of the electric motor 98a is connected to a third port of the valve 84a.

A third port of the valve 76a is connected to an inlet of a cold side of the heat pump 88a. An outlet of the cold side of the heat pump 88a is connected to the second port of the valve 82a.

The outlet of the pump 36a is connected to a first port of the valve 74a. A second port of the valve 74a is connected to the inlet of the first side 94a of the heat exchanger of the vehicle cooler 112a.

In the present case, the thermal management topology 86a permits an exchange of heat between components of the interior compartment ventilation system 90a, components of the drivetrain, including for example the electric motor 98a, the inverter 100a and the charger 102, and components of the energy store 92a. It is self-evidently the case that partially or entirely different thermal management topologies are conceivable, for example in the case of a vehicle with an internal combustion engine and/or with a hybrid drivetrain. For example, it is also conceivable for a charger and an inverter to be connected in parallel rather than in series in a heat circuit. Furthermore, it is possible for some or all of the coolant flows to run in an opposite direction, for example through the electric motor 98a and/or the inverter 100a and/or the charger.

Furthermore, it is conceivable for a thermal management topology to comprise additional components and/or for sub-circuits shown here to be combined and/or to be divided into multiple further sub-circuits. For example, it is conceivable for a vehicle to have multiple electric motors and/or multiple batteries which may correspondingly be arranged in series and/or in parallel with one another in a thermal management topology. In particular in the case of large vehicles, it is also conceivable for a vehicle ventilation system to comprise more than one heat pump. It is self-evidently also conceivable for an internal heat circuit of a heat-exchange unit to additionally lead through particular components of a thermal management topology, such as for example through components of an interior compartment ventilation system.

The first operating state illustrated in FIG. 1 corresponds to a winter pre-conditioning operating mode. In the first operating mode, the energy store 92a is wound up. The first heat circuit 18a runs through the second throughflow region 16a and through the heat exchanger of the vehicle cooler 112a. The second heat circuit 20a runs through the first throughflow region 14a. A first sub-circuit of the second heat circuit 20a runs through the heat pump 88a of the interior compartment ventilation system 90a. A second sub-circuit of the second heat circuit 20a runs through the energy store 92a. In the first operating mode, the energy store 92a is warmed up, in particular prior to operation of the vehicle. In the first operating state, the auxiliary heater 24a generates heat in accordance with demand, which heat is supplied to the second heat circuit 20a.

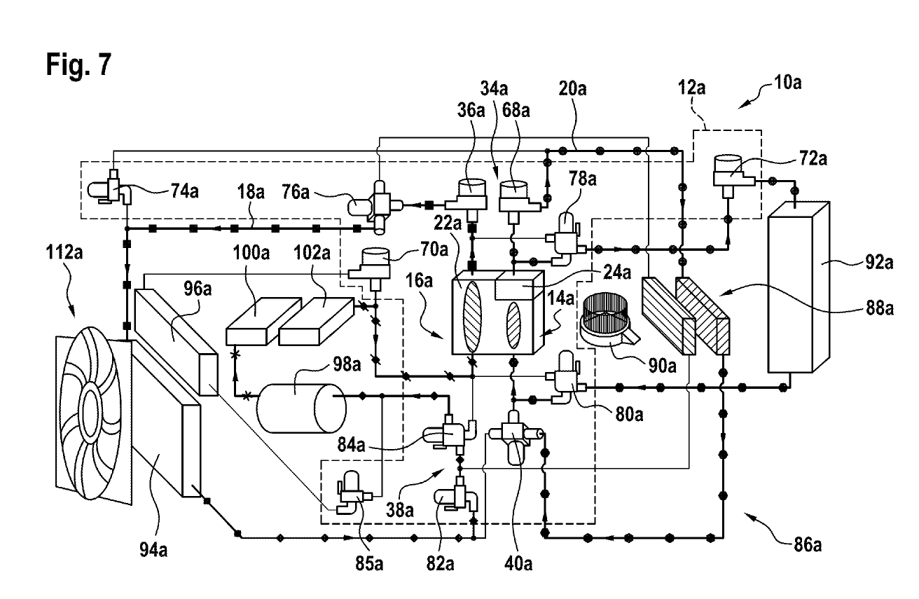

FIG. 7 illustrates the vehicle apparatus 10a in a second operating state. The second operating state corresponds to a winter operating mode. The first heat circuit 18a runs through the second throughflow region 16a, the heat exchanger of the vehicle cooler 112a, the electric motor 98a, the inverter 100a and the charger 102a. The second heat circuit 20a is configured correspondingly to the first operating state. In the second operating mode, it is the case, for example during travel, that the drivetrain of the electric vehicle is cooled and the energy store 92a is warmed up.

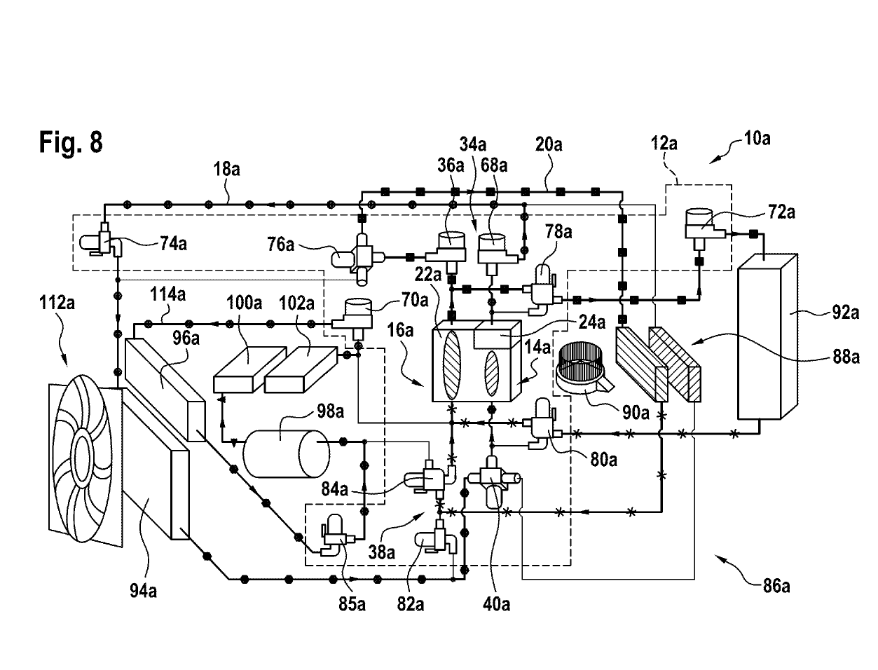

FIG. 8 illustrates the vehicle apparatus 10a in a third operating state. The third operating state corresponds to a summer operating mode. The first heat circuit 18a runs through the first throughflow region 14a and through the heat exchanger of the vehicle cooler 112a. The second heat circuit 20a runs through the second throughflow region 16a. A first sub-branch of the second heat circuit 20a runs through the cold side of the heat pump 88a of the interior compartment ventilation system 90a. A second sub-branch of the second heat circuit 20a runs through the energy store 92a. A third heat circuit 114a runs through the heat exchanger of the vehicle cooler 112a, the electric motor 98a, the inverter 100a and the charger 102a. The third heat circuit 114a cools the drivetrain independently of the operation of the heat-exchange unit 22a. In the third operating mode, the energy store 92a is cooled.

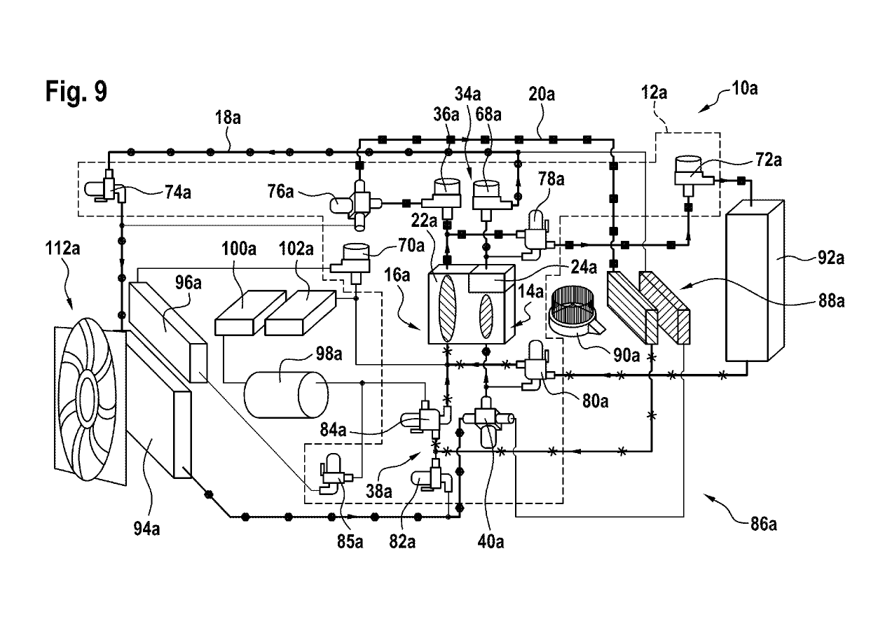

FIG. 9 illustrates the vehicle apparatus 10a in a fourth operating state. The fourth operating state corresponds to a summer pre-conditioning operating mode. The first heat circuit 18a and the second heat circuit 20a are configured correspondingly to the third operating mode. In the fourth operating mode, however, no coolant circulates through the drivetrain because the latter is not yet in use, for example prior to a start of operation of the electric motor vehicle. In the fourth operating state, the energy store 92a is cooled to operating temperature.

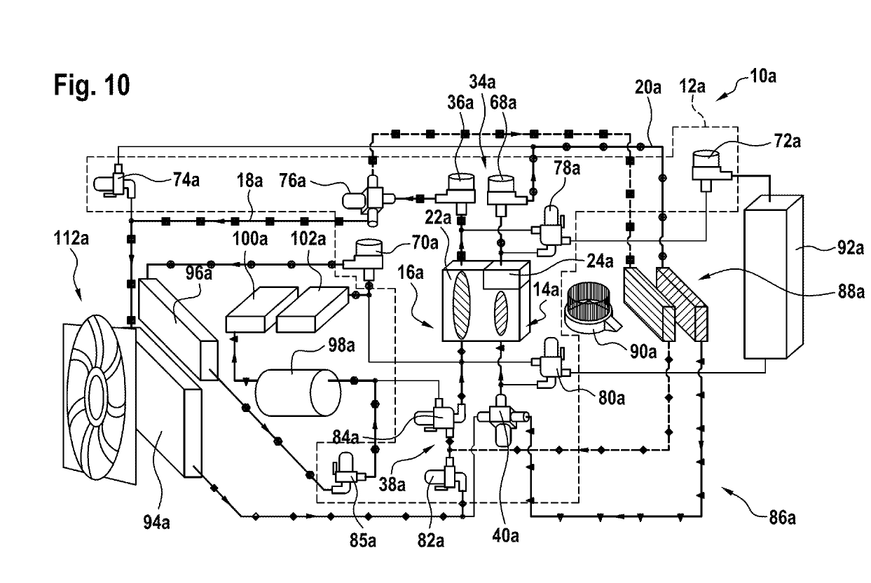

In FIG. 10, the vehicle apparatus 10a is illustrated in a fifth operating state. The fifth operating state corresponds to a window demisting operating mode in which any misted windows of the electric vehicle are demisted. The fifth operating state may alternatively or additionally also be used for de-icing of vehicle windows. The first heat circuit 18a runs through the second throughflow region 16a. The first heat circuit 18a has a first sub-circuit which runs through the heat exchanger of the vehicle cooler 112a. Furthermore, the first heat circuit 18a has a second sub-circuit which can be activated in accordance with demand and which runs through the cold side of the heat pump 88a of the interior compartment ventilation system 90a. In particular, the second sub-circuit of the first heat circuit 18a is activated in a manner dependent on an interior compartment temperature and/or an ambient temperature and/or an air humidity. The second heat circuit 20a runs through the first throughflow region 14a and through the hot side of the heat pump 88a of the interior compartment ventilation system 90a. If the fifth operating mode is selected during driving operation, it is furthermore the case that the drivetrain is cooled by way of the vehicle cooler 112a in particular independently of the heat-exchange unit 22a.

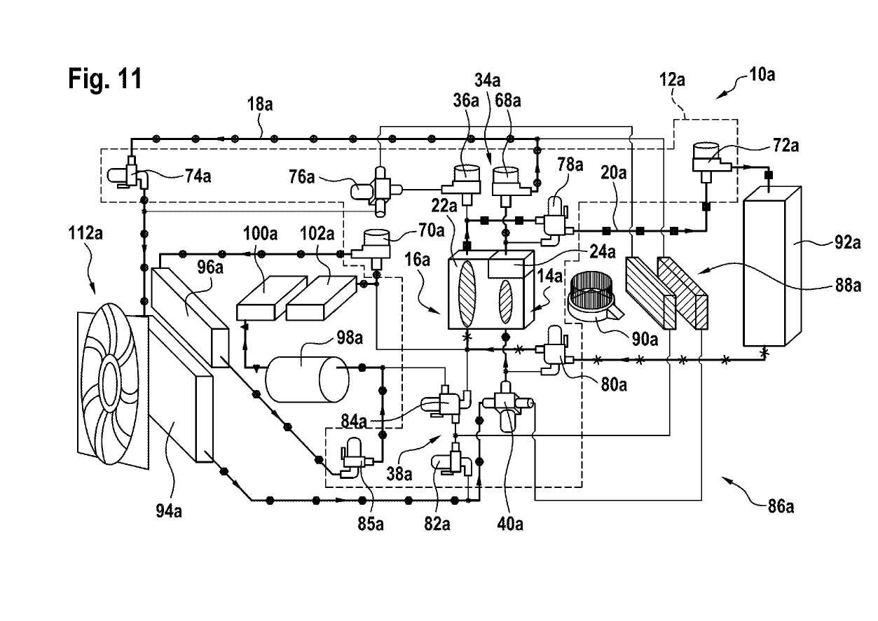

FIG. 11 illustrates the vehicle apparatus 10a in a sixth operating state. The sixth operating state corresponds to a fast-charging operating mode which may be provided for fast charging of the energy store 92a. The first heat circuit 18a runs through the first throughflow region 16a and the vehicle cooler 112a. The second heat circuit 20a runs through the second throughflow region 16a and the energy store 92a. Furthermore, the drivetrain, in particular the inverter 100a and the charger 102a, are cooled by way of the vehicle cooler 112a. In the sixth operating state, the energy store 92a is cooled, in particular in order to realize a high level of efficiency during charging of the energy store 92a and/or in order to prevent overheating of the energy store 92a during charging.

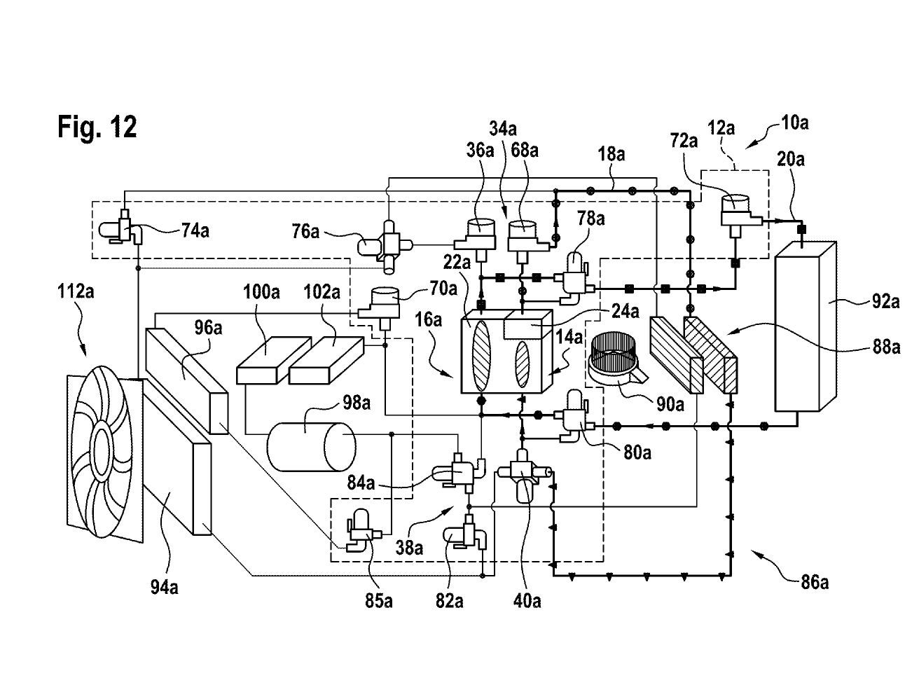

FIG. 12 illustrates the vehicle apparatus 10a in a seventh operating state. The seventh operating state corresponds to a battery heat operating mode which permits utilization of heat present and/or stored in the battery. The first heat circuit 18a runs through the second throughflow region 16a and through the energy store 92a. The second heat circuit 20a runs through the first throughflow region 14a and the hot side of the heat pump 88a of the interior compartment ventilation system 90a. In the seventh operating state, it is possible for heat of the energy store 92a to be used for heating the interior compartment.

Alternatively or in addition to the valve 40a, it is also possible for the valve 76a and/or the valve 78a and/or the valve 80a and/or the valve 84a to be in the form of a proportional valve. In particular for the valves 78a and/or 80a, it is possible in this way for a pressure drop in a supply line of the energy store 92a to be adapted or reduced. It is advantageously possible in this case for a flow through the energy store 92a to be controlled and/or regulated in targeted fashion.

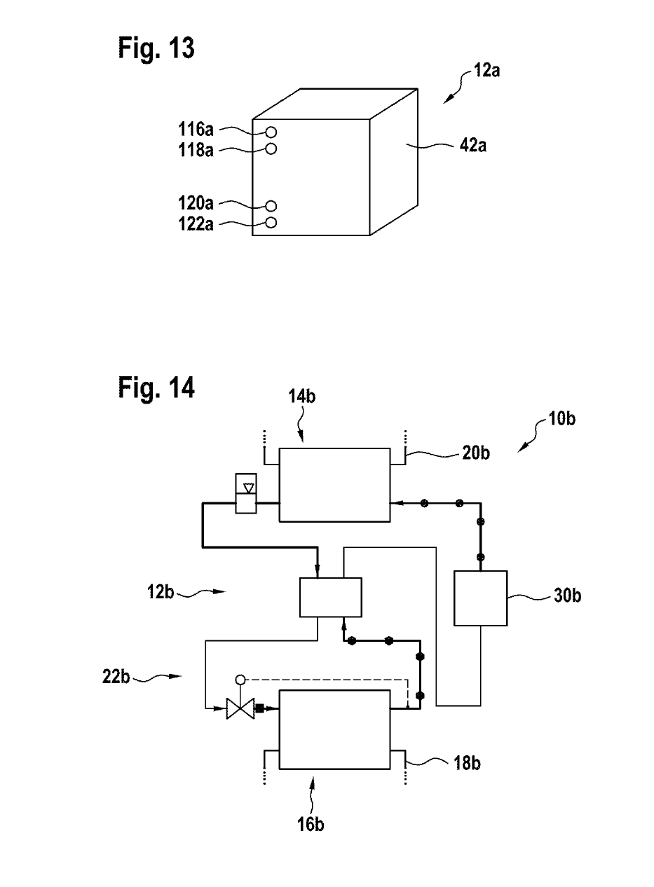

FIG. 13 shows the thermal management unit 12a of the vehicle apparatus 10a in a schematic illustration. The thermal management unit 12a is in the form of a separate structural unit. In the present case, the thermal management unit 12a is a thermal management module. The thermal management unit 12a has a housing unit 42a which houses at least the thermal management unit 22a. In the present case, the housing unit 42a houses all of the components of the thermal management unit 12a. The housing unit 42a has ports 116a, 118a, 120a, 122a for the first heat circuit 18a and for the second heat circuit 20a. In the present case, the ports 116a, 118a, 120a, 122a are in the form of plug-type connectors which are connectable to coolant lines without the use of tools. For the sake of clarity, only four ports 116a, 118a, 120a, 122a are illustrated. The thermal management unit 12a self-evidently has a number of ports which enables the thermal management unit 12a to be connected into the thermal management topology 86a shown. A number of ports of a thermal management unit is correspondingly adaptable in accordance with requirements.

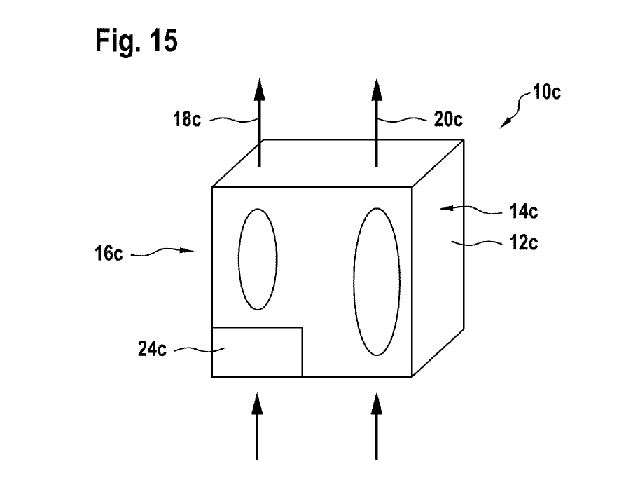

FIGS. 14 and 15 show two further exemplary embodiments of the invention. The following descriptions and the drawings are limited substantially to the differences between the exemplary embodiments, wherein, with regard to components of identical designation, in particular with regard to components with the same reference designations, reference may basically also be made to the drawings and/or to the description of the other exemplary embodiment, in particular of FIGS. 1 to 12. For distinction of the exemplary embodiments, the character a has been added as a suffix to the reference designations of the exemplary embodiment in FIGS. 1 to 12. In the exemplary embodiments of FIGS. 14 and 15, the character a has been replaced by the characters b and c.

FIG. 14 shows a second vehicle apparatus 10b in a schematic illustration. The second vehicle apparatus 10b has a thermal management unit 12b. The thermal management unit 12b has a first throughflow region 14b and a second throughflow region 16b which are connectable in accordance with demand in each case to a first heat circuit 18b and/or to a second heat circuit 20b. The thermal management unit 12b has a heat-exchange unit 22b. The heat-exchange unit 22b, in at least one operating state, exchanges heat between the first throughflow region 14b and the second throughflow region 16b. The heat-exchange unit 22b comprises at least one electrochemical compressor 30b. The heat-exchange unit 22b is basically of analogous construction to the heat-exchange unit 22a from the exemplary embodiment of FIGS. 1 to 13, but has the electrochemical compressor 30b instead of the compressor 48b.

FIG. 15 shows a third vehicle apparatus 10c in a schematic illustration. The third vehicle apparatus 10c has a thermal management unit 12c. The thermal management unit 12c has a first throughflow region 14c and a second throughflow region 16c which are connectable in accordance with demand in each case to a first heat circuit 18c and/or to a second heat circuit 20c. The heat management unit 12c has a heat-exchange unit 22c. The heat-exchange unit 22c, in at least one operating state, exchanges heat between the first throughflow region 14c and the second throughflow region 16c. The thermal management unit 12c has at least one auxiliary heater 24c which, in the operating state, generates heat in accordance with demand for the second throughflow region 16c. In the present case, the second throughflow region 16c is assigned to a cold side of the heat-exchange unit 22c. An arrangement of said type constitutes an alternative to the arrangement of the auxiliary heater 24a as per the exemplary embodiment as per FIGS. 1 to 13, in which the auxiliary heater 24a is assigned to a hot side.

1. A vehicle apparatus (10a; 10b; 10c) comprising at least one thermal management unit (12a; 12b; 12c) which has at least one first throughflow region (14a; 14b; 14c) and at least one second throughflow region (16a; 16b; 16c), which are connectable in accordance with demand in each case to a first heat circuit (18a) and/or to a second heat circuit (20a), and has a heat-exchange unit (22a; 22b; 22c) which, in at least one operating state, exchanges heat in accordance with demand between the first throughflow region (14a; 14b; 14c) and the second throughflow region (16a; 16b; 16c), characterized in that the first throughflow region (14a; 14b; 14c) and the second throughflow region (16a; 16b; 16c) are configured to be flowed through in each case by a heat-transporting liquid which differs from a refrigerant.

2. The vehicle apparatus (10a; 10c) according to claim 1, characterized in that the thermal management unit (12a; 12c) has at least one auxiliary heater (24a; 24c) which, in the operating state, generates heat in accordance with demand for the first throughflow region (14a; 14c) and/or for the second throughflow region (16a; 16c).

3. The vehicle apparatus (10a) according to claim 2, characterized in that the auxiliary heater (24a) comprises at least one heating element (26a) which has at least one material (28a) with a positive temperature coefficient.

4. The vehicle apparatus (10b) according to claim 1, characterized in that the heat-exchange unit (22b) comprises at least one electrochemical compressor (30b).

5. The vehicle apparatus (10a; 10b) according to claim 1, characterized in that the heat-exchange unit (22a; 22b) comprises at least one heat pump (32a; 32b) for heat exchange.

6. The vehicle apparatus (10a) according to claim 1, characterized in that the thermal management unit (12a) has a pump unit (34a) which comprises at least one pump (36a) which, in the operating state, generates a flow in the first throughflow region (14a) and/or in the second throughflow region (16a).

7. The vehicle apparatus (10a) according to claim 1, characterized in that the thermal management unit (12a) has a switching unit (38a) which comprises at least one valve (40a) by means of which a connection state of the first heat circuit (18a) and of the second heat circuit (20a) to the heat-exchange unit (22a) can be adapted in accordance with demand.

8. The vehicle apparatus (10a) according to claim 7, characterized in that the valve (40a) is a multi-way valve and/or a proportional valve.

9. The vehicle apparatus (10a) according to claim 1, characterized in that the thermal management unit (12a) is in the form of a separate structural unit.

10. The vehicle apparatus (10a) according to claim 9, characterized in that the thermal management unit (12a) has a housing unit (42a) which houses at least the heat-exchange unit (22a).

11. The vehicle apparatus (10a) according to claim 10, characterized in that the housing unit has ports (116a, 118a, 120a, 122a) for the first heat circuit (18a) and for the second heat circuit (20a).

12. The vehicle apparatus (10a) according to claim 1, wherein the first heat circuit (18a) and the second heat circuit (20a) are, in the operating state, in each case flowed through by a coolant.

13. The vehicle apparatus according to claim 1, further comprising a heat-transporting liquid which differs from a refrigerant, the heat-transporting liquid flowing through the first throughflow region (14a; 14b; 14c) and the second throughflow region (16a; 16b; 16c).

14. A vehicle comprising a vehicle apparatus (10a; 10b; 10c) according to claim 1.

15. A vehicle apparatus (10a; 10b; 10c) comprising at least one thermal management unit (12a; 12b; 12c) which has at least one first throughflow region (14a; 14b; 14c) and at least one second throughflow region (16a; 16b; 16c), which are connectable in accordance with demand in each case to a first heat circuit (18a) and/or to a second heat circuit (20a), and has a heat-exchange unit (22a; 22b; 22c) which, in at least one operating state, exchanges heat in accordance with demand between the first throughflow region (14a; 14b; 14c) and the second throughflow region (16a; 16b; 16c), characterized in that the thermal management unit (12a; 12c) has at least one auxiliary heater (24a; 24c) which, in the operating state, generates heat in accordance with demand for the first throughflow region (14a; 14c) and/or for the second throughflow region (16a; 16c).

16. The vehicle apparatus (10a) according to claim 15, characterized in that the auxiliary heater (24a) comprises at least one heating element (26a) which has at least one material (28a) with a positive temperature coefficient.

17. A vehicle comprising a vehicle apparatus according to claim 15.
